(19) United States
(12) Patent Application Publication
(10) Pub. No.: US 2024/0127027 A1
(43) Pub. Date: Apr. 18, 2024

(54) OPTIMIZATION METHOD AND APPARATUS FOR COMPILING COMPUTATION GRAPH

(71) Applicant: ZHEJIANG LAB, Hangzhou (CN)

(72) Inventors: Hongsheng WANG, Hangzhou (CN); Shuibing HE, Hangzhou (CN); Guang CHEN, Hangzhou (CN)

(21) Appl. No.: 17/992,814

(22) Filed: Nov. 22, 2022

Related U.S. Application Data
(63) Continuation of application No. PCT/CN2022/124001, filed on Oct. 9, 2022.

(30) Foreign Application Priority Data
Sep. 27, 2022 (CN) 202211177796.9

(51) Int. Cl. G06N 3/04

(52) U.S. Cl. CPC G06N 3/04

(57) ABSTRACT

Disclosed are an optimization method and apparatus for compiling computation graph. The optimization method includes the following steps: step S1: converting a computation graph into an intermediate representation; step S2: analyzing a dependency relationship; step S3: constructing a work stack; step S4: performing initialization to achieve a nonactivated state; step S5: popping out stack top node elements, and updating an input node set in a current round of iteration; step S6: adding the stack top node elements that depend on step S5 to a stack top position in sequence until the work stack is empty; step S7: implementing an intermediate representation in a fixed node state using a bit vector; and step S8: allocating registers for effective tensor variables contained in nodes of the intermediate representation in the fixed node state.

This application claims priority to Chinese patent application No. 202211177796.9, filed with the China National Intellectual Property Administration on Sep. 27, 2022, the disclosure of which is incorporated by reference herein in its entirety.

### TECHNICAL FIELD

The disclosure relates to the technical field of computer systems based on specific computation models, in particular to an optimization method and apparatus for compiling a computation graph.

### BACKGROUND

With the implementation of a neural network model in recent years, a neural network compiling-oriented technology has become more and more important. The neural network model using deep learning technology needs to use a lot of training data, which brings a huge processing burden to the computer processing system using neural network model. Existing computation graph compiling technologies have not analyzed a constraint relationship between nodes in an execution process of a computation graph from the global perspective, and have not analyzed, on the basis of the constraint relationship, dynamic changes of the life cycle of tensor variables contained in the nodes of the computation graph in different states in the execution process. This makes the computer consume more memory resources when processing the task containing the neural network model, and the CPU's register resource consumption is also more strained.

To this end, the disclosure proposes to abstract a dynamic change process of a node state in the execution process of the computation graph into a constraint-based set representation method, and provides an intermediate representation technology based on a set of nodes containing tensor variables.

### SUMMARY

In order to solve the above technical problems, the disclosure provides an optimization method and apparatus for compiling a computation graph.

The technical solution adopted by the disclosure is as follows:

An optimization method for compiling a computation graph includes the following steps:
converting a computation graph into an intermediate representation based on a set of nodes containing tensor variables;
analyzing a dependency relationship among nodes in the computation graph;
constructing and saving a work stack of a node to be processed;
initializing node elements contained in the work stack to be in a nonactivated state;
popping out stack top node elements from the work stack, deducing an input node set of the stack top node elements by using the dependency relationship, and updating the input node set of the stack top node elements obtained in a current round of iteration;
adding the stack top node elements that depend on the last step to a stack top position in sequence, updating the current work stack, and repeating the last step until the work stack is empty;
implementing an intermediate representation in a fixed node state by using a bit vector; and
allocating registers for tensor variables contained in nodes of the intermediate representation in the fixed node state.

Further, converting the computation graph into the intermediate representation specifically includes the following sub-steps:
expressing a node of the computation graph containing tensor variables as an equation composed of a definition of a tensor variable and an expression by using the tensor variable;
defining an input node set of nodes containing tensor variables from the nodes of the computation graph, the input node set being a union set of all the precursor nodes of the nodes of the computation graph;
defining an output node set of nodes containing tensor variables from the nodes of the computation graph, the output node set being a union set of a set obtained by removing the node containing redefined tensor variables from the input node set and a set of nodes containing tensor variables at node positions of the tensor variables; and
acquiring sets of nodes of the intermediate representation that contain the tensor variables by means of iteratively deducing that each node contains a tensor variable, until the input node sets and the output node sets of all the nodes no longer change, i.e. the sets contain fixed nodes; and defining the sets containing the fixed nodes as intermediate representations based on the sets of the nodes containing the tensor variables.

Further, analyzing the dependency relationship includes: analyzing and deducing a relationship among the input node sets of the various nodes of the computation graph.

Further, constructing and saving the work stack: traversing the computation graph according to a topological order, and pressing the nodes in the computation graph into the work stack in sequence.

Further, initializing the node elements includes: initializing all the nodes of the computation graph that have not been executed to be in a nonactivated state.

Further popping out the stack top node elements from the work stack includes the following sub-steps:
popping out a stack top node element from the work stack, i.e. popping out a stack top node element of the work stack from the stack; and
adding the input node set of the pop-out stack top node element into the work stack by using the dependency relationship, and updating the input node set of the stack top node element obtained in the current round of iteration.

Further, implementing the intermediate representation in the fixed node state includes: mapping, when the input node set of the various nodes in the intermediate representation of the computation graph reaches the fixed node state, node elements contained to 1, and mapping other node elements to 0.

Further, allocating the registers for the tensor variables includes: allocating idle registers for tensor variables contained in nodes whose node elements contained are mapped to 1 when the input node set reaches the fixed node state.

The disclosure further provides an optimization apparatus for compiling a computation graph, including a memory and one or more processors, the memory stores executable instructions; and the one or more processors execute the executable instructions to implement the optimization method for compiling a computation graph according to any one of the above embodiments.

The disclosure further provides a computer-readable storage medium, which stores programs, the programs, when executed by a processor, implements the optimization method for compiling a computation graph according to any one of the above embodiments.

The beneficial effects of the disclosure are as follows: The disclosure discloses an optimization method and device for compiling a computation graph. The method is an optimization method for compiling a computation graph. The disclosure proposes conversion of a computation graph into an intermediate representation based on a set of nodes containing tensor variables, and provides a method for analyzing that nodes of the intermediate representation are dynamically executed to a fixed node state, and optimizes an implementation method for allocating the idle registers to the tensor variables contained in the various nodes of the intermediate representation in the fixed node state. Through the above optimization method for compiling a computation graph, a work stack for the intermediate representation is used to improve the utilization efficiency of compiling memory, reduce the required amount computer memory resources for running a neural network model, save the register resources of CPU cores which need to be allocated when the neural network model is running on the computer, and finally improve data training efficiency and data input and output efficiency of the neural network model. The optimization method for compiling a computation graph of the disclosure improves the execution efficiency of the computation graph at runtime. In the process of developing algorithm models, researchers and engineering users use the optimization method and apparatus for compiling a computation graph to optimize the models, thus optimizing the compiling efficiency of the computation graph and promoting the development of implementation and application of a neural network model in the relational graph.

### BRIEF DESCRIPTION OF FIGURES

FIG. 1 is an architecture diagram of an optimization method for compiling a computation graph of the disclosure;

FIG. 2 is a computation graph generated by neural network compiling according to the disclosure;

FIG. 3 is a definition of a set-based intermediate representation according to an embodiment of the disclosure;

FIG. 4 is a set of nodes containing tensor variables of the intermediate representation deduced in a first round of iteration according to an embodiment of the disclosure;

FIG. 5 is a set of nodes containing tensor variables of the intermediate representation deduced in a second round of iteration according to an embodiment of the disclosure;

FIG. 6 is a diagram of a constraint relationship between input sets of various nodes of a computation graph according to an embodiment of the disclosure; and

FIG. 7 is a schematic structural diagram of an optimization apparatus for compiling a computation graph of the disclosure.

### DETAILED DESCRIPTION

The following description of at least one exemplary embodiment is merely illustrative in nature and is in no way intended to limit the disclosure and its application or uses. Based on the embodiments in the disclosure, all other embodiments obtained by those of ordinary skill in the art without doing creative work shall fall within the protection scope of the disclosure.

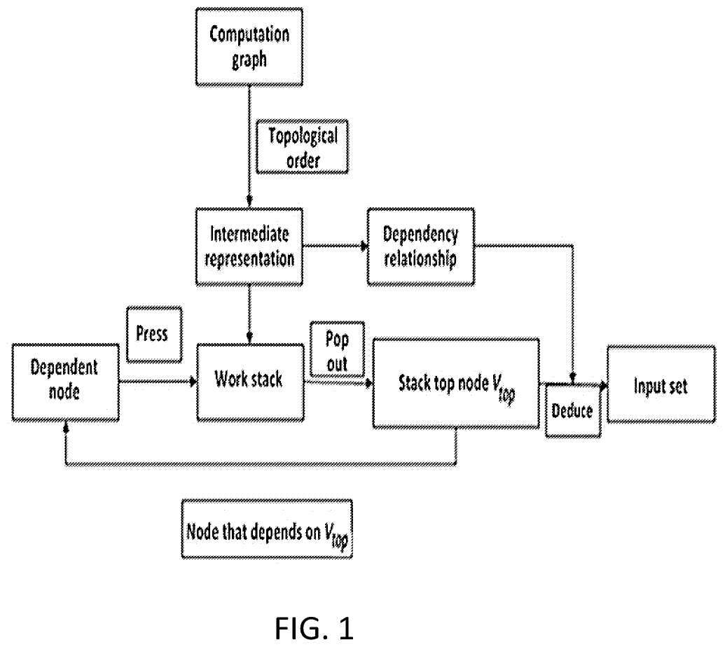

Referring to FIG. 1, an optimization method for compiling a computation graph includes the following steps:
a computation graph is converted into an intermediate representation based on a set of nodes containing tensor variables:
a node of the computation graph containing tensor variables is expressed as an equation composed of a definition of a tensor variable and an expression by using the tensor variable;
an input node set of nodes containing tensor variables from the nodes of the computation graph is defined, the input node set being a union set of all the precursor nodes of the nodes of the computation graph;
an output node set of nodes containing tensor variables from the nodes of the computation graph is defined, the output node set being a union set of a set obtained by removing the node containing redefined tensor variables from the input node set and a set of nodes containing tensor variables at node positions of the tensor variables; and
sets of nodes of the intermediate representation that contain the tensor variables are acquired by means of iteratively deducing that each node contains an tensor variable, until the input node sets and the output node sets of all the nodes no longer change, i.e. the sets contain fixed nodes; and the sets containing the fixed nodes are defined as intermediate representations based on the sets of the nodes containing the tensor variables.
a dependency relationship among nodes in the computation graph is analyzed:
a relationship between the input node sets of the various nodes of the computation graph is analyzed and deduced.
a work stack of a node to be processed is constructed and saved:
the computation graph is traversed according to a topological order, and the nodes in the computation graph are pressed into the work stack in sequence.
node elements contained in the work stack are initialized to be in a nonactivated state:
all the nodes of the computation graph that have not been executed are initialized to be in the nonactivated state.
stack top node elements are popped out from the work stack, an input node set of the stack top node elements are deduced by using the dependency relationship, and the input node set of the stack top node elements obtained in a current round of iteration is updated:
a stack top node element is popped out from the work stack, i.e. a stack top node element of the work stack is popped out from the stack; and
the input node set of the pop-out stack top node element is added into the work stack by using the dependency relationship, and the input node set of the stack top node element obtained in the current round of iteration is updated.
stack top node elements that depend the last step are added to a stack top position in sequence, the current work stack is updated, and the last step is repeated until the work stack is empty:
an intermediate representation in a fixed node state is implemented by using a bit vector:
node elements contained are mapped to 1 when the input node sets of the various nodes in the intermediate representation of the computation graph reach the fixed node state, and other node elements are mapped to 0.
registers are allocated for tensor variables contained in nodes of the intermediate representation that achieves the fixed node state.
idle registers are allocated for tensor variables contained in nodes whose node elements contained are mapped to 1 when the input node sets in the last step reach the fixed node state.

### Embodiments

{ } in this embodiment represents an empty set, and sign [symbol] represents a nonactivated state;
tf.matmul(x, y) represents performing a matrix multiplication operation on a tensor x and a tensor y;
tf.ones(aᵢ.shape) represents establishing a tensor which has the same shape as that of a tensor aᵢ and has all the elements of 1;
tf.nn.relu(x) represents inputting the tensor x into a linear rectification unit;
   |x| represents a model of a tensor variable x.

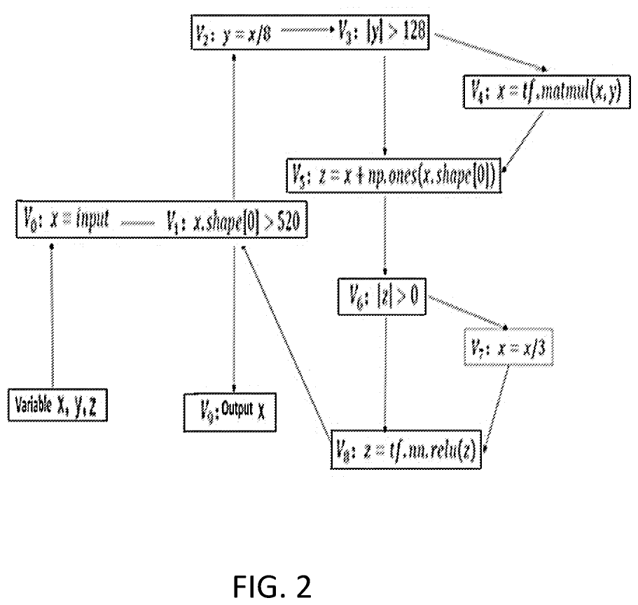

An optimization method for compiling a computation graph includes the following steps:
referring to FIG. 2, showing a computation graph generated by neural network compiling, a computation graph is converted into an intermediate representation based on a set of nodes containing tensor variables;
a node of the computation graph containing tensor variables is expressed as an equation composed of a definition of a tensor variable and an expression by using the tensor variable.

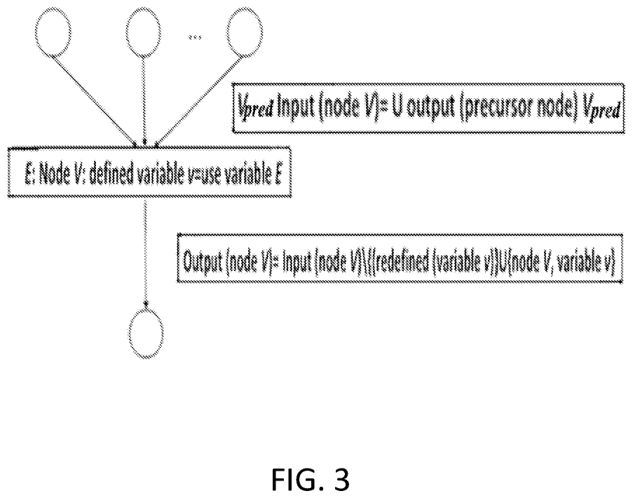

Referring to FIG. 3, a definition process of an intermediate representation of a set of nodes containing tensor variables is shown. A node of the computation graph containing the tensor variable v is expressed as an equation composed of a definition of the tensor variable v and an expression E by using the tensor variable v.
an input node set of nodes containing tensor variables from the nodes of the computation graph is defined, the input node set being a union set of all the precursor nodes of the nodes of the computation graph;
the input node set of the nodes containing the tensor variable v is defined as a union set of all the precursor nodes V_{pred} of the node V.
an output node set of nodes containing tensor variables from the nodes of the computation graph is defined, the output node set being a union set of a set obtained by removing nodes containing redefined tensor variables from the input node set and a set of nodes containing tensor variables at node positions of the tensor variables;
the set of the nodes containing the defined tensor variable v is expressed as: {(node V, variable v)}. The set of the nodes containing the redefined tensor variable v is expressed as: {redefined (variable v)}, a set element of the node containing the tensor variable v of the intermediate representation is two-dimensional information containing the node and the tensor variable, such as V (tensor variable V), including node information V and information of the tensor variable v contained in the node.
sets of nodes of the intermediate representation that contain the tensor variables are acquired by means of iteratively deducing that each node contains an tensor variable, until the input node sets and the output node sets of all the nodes no longer change, i.e. the sets contain fixed nodes; and the sets containing the fixed nodes are defined as intermediate representations based on the sets of the nodes containing the tensor variables.

The sets of the nodes containing the tensor variables of the intermediate representation are acquired by means of iteratively deducing that each node contains a tensor variable, until the input node sets and the output node sets of all the nodes no longer change, i.e. until the node elements contained in all the sets are fixed nodes. The iteration process is as follows:

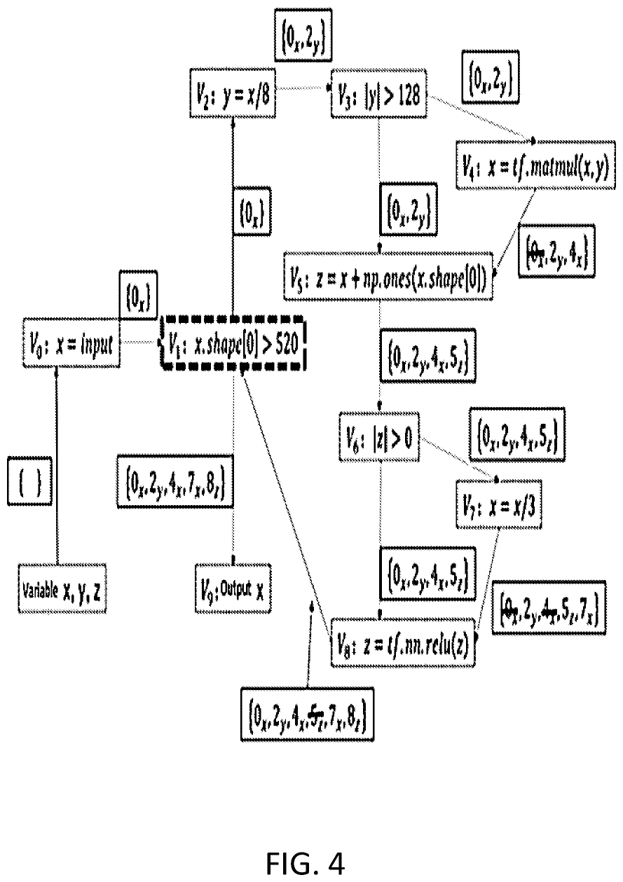

Referring to FIG. 4, a process of deducing a set of nodes containing tensor variables of the intermediate representation in a first round of iteration is shown.

In the first round of iteration, the input node set and the output node set of each node change below:
(1) For a set representation of a node V₀:
1.1 For the input node set of the nodes V₀ containing a tensor variable: the input node set of the nodes V₀ is an empty set, which is denoted as V₀_IN={ }.
1.2 For the output node set of the node V₀ containing a tensor variable: the node V₀ defines the tensor variable x, so that the output node set of the node V₀ is the node V₀ containing the tensor variable x, which is denoted as V₀_OUT={0ₓ}.
(2) For a set representation of a node V₁:
2.1 For the input node set of the nodes V₁ containing a tensor variable: the various nodes of the computation graph are accessed in a node order. Starting from the node V₁, the input node set of the nodes V₁ is equal to the output node set of the node V₀, which is denoted as. V₁_IN={0ₓ}
2.2 For the output node set of the node V₁ containing a tensor variable: the output node set of the node V₁ is equal to the input node set of the nodes V₁, which is denoted as V₁_OUT={0ₓ}.
(3) For a set representation of a node V₂:
3.1 For the input node set of the nodes V₂ containing a tensor variable: the input node set of the nodes V₂ is equal to the output node set of the node V₁, which is denoted as V₂_IN={0ₓ}.
3.2 For the output node set of the node V₂ containing a tensor variable: since the node V₂ defines a tensor variable y, the output node set of the node V₂ is a union set of the input node set of the nodes V₂ and the set of the node V₂ containing the tensor variable y, which is denoted as V₂_OUT={0ₓ, 2_{y}}.
(4) For a set representation of a node V₃:
4.1 For the input node set of the nodes V₃ containing a tensor variable: the input node set of the nodes V₃ is equal to the output node set of the node V₂, which is denoted as V₃_IN={0ₓ, 2_{y}}.
4.2 For the output node set of the node V₃ containing a tensor variable: the output node set of the node V₃ is equal to the input node set of the nodes V₃, which is denoted as V₃_OUT={0ₓ, 2_{y}}.
(5) For a set representation of a node V₄:
5.1 For the input node set of the nodes V₄ containing a tensor variable: the input node set of the nodes V₄ is equal to the output node set of the node V₃, which is denoted as V₄_IN={0ₓ, 2_{y}}.
5.2 For the output node set of the node V₄ containing a tensor variable: since the node V₄ redefines the tensor variable x, the output node set of the node V₄ is a union set of a set obtained by removing the node V₀ containing the tensor variable x from the input node set of the nodes V₄ and the set of the node V₄ defined by the tensor variable x, which is denoted as V₄_OUT={2_{y}, 4ₓ}.
(6) For a set representation of a node V₅:
6.1 For the input node set of the nodes V₅ containing a tensor variable: the input node set of the nodes V₅ a union set of the output node sets of the precursor node V₃ and node V₄, which is denoted as V₅_IN=V₃_OUT∪V₄_OUT={0ₓ, 2_{y}, 4ₓ}.
6.2 For the output node set of the node V₅ containing a tensor variable: since the node V₅ defines a tensor variable z, the output node set of the node V₅ is a union set of the input node set of the nodes V₅ and the set of the node V₅ containing the tensor variable z, which is denoted as V₅_OUT={0ₓ, 2_{y}, 4ₓ, 5_{z}}.
(7) For a set representation of a node V₆:
7.1 For the input node set of the nodes V₆ containing a tensor variable: the input node set of the nodes V₆ is equal to the output node set of the node V₅, which is denoted as V₆_IN={0ₓ, 2_{y}, 4ₓ, 5_{z}}.
7.2 For the output node set of the node V₆ containing a tensor variable: the output node set of the node V₆ is equal to the input node set of the nodes V₆, which is denoted as V₆_OUT={0ₓ, 2_{y}, 4ₓ, 5_{z}}.
(8) For a set representation of a node V₇:
8.1 For the input node set of the nodes V₇ containing a tensor variable: V₇_IN=V₆_OUT={0ₓ, 2_{y}, 4ₓ, 5_{z}}.
8.2 For the output node set of the node V₇ containing a tensor variable: since the node V₇ redefines the tensor variable x, the output node set of the node V₇ is a union set of a set obtained by removing the node V₀ containing the tensor variable x and the node V₄ containing the tensor variable x from the input node set of the nodes V₇ and the set of the node V₇ defined by the tensor variable x, which is denoted as V₇_OUT={2_{y}, 5_{z}, 7ₓ}.
(9) For a set representation of a node V₈:
9.1 For the input node set of the nodes V₈ containing a tensor variable: the input node set of the nodes V₈ is a union set of the output node sets of the precursor node V₆ and node V₇, which is denoted as V₈_IN=V₆_OUT∪V₇_OUT={0ₓ, 2_{y}, 4ₓ, 5_{z}, 7ₓ}.
9.2 For the output set of the node V₈ containing a tensor variable: since the node V₈ defines the tensor variable z, the output node set of the node V₈ is a union set of a set obtained by removing the node V₅ containing the tensor variable z from the input node set of the nodes V₈ and the set of the node V₈ defined by the tensor variable z, which is denoted as V₈_OUT={0ₓ, 2_{y}, 4ₓ, 7ₓ, 8_{z}}.
(10) For a set representation of a node V₉:
10.1 For the input node set of the nodes V₉ containing a tensor variable: the input node set of the nodes V₉ is the output node set of the precursor node V₁, which is denoted as _{J}V₉_IN=V₁_OUT={0ₓ}.

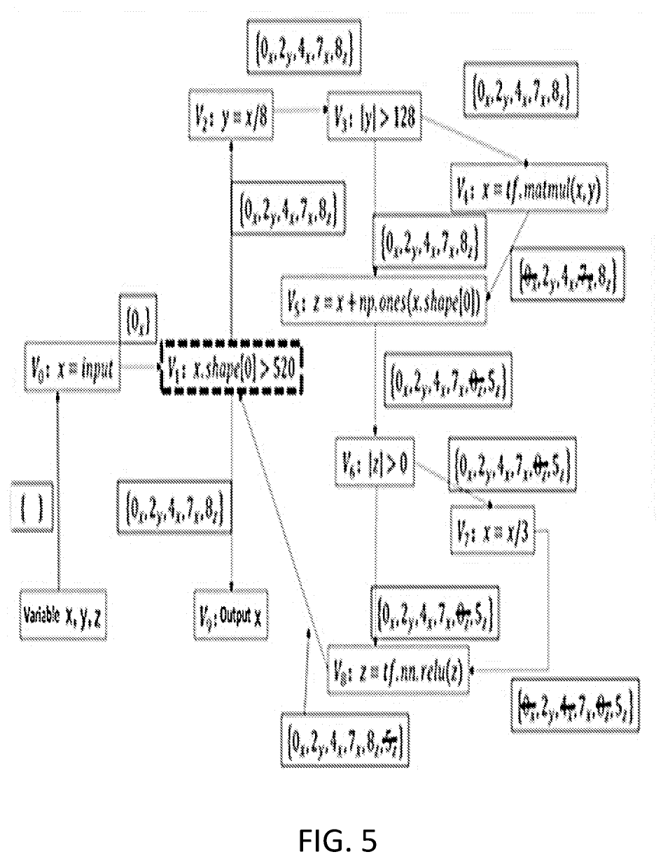

Referring to FIG. 5, a process of deducing a set of a node containing tensor variables of the intermediate representation in a second round of iteration is shown.

In the second round of iteration, the input node set and the output node set of each node change below:
(1) For a set representation of the node V₀:
1.1 For the input node set of the nodes V₀ containing a tensor variable: the input node set of the nodes V₀ is an empty set, which is denoted as V₀_IN={ }.
1.2 For the output node set of the node V₀ containing a tensor variable: the node V₀ defines the tensor variable x, so that the output node set of the node V₀ is the node V₀ containing the tensor variable x, which is denoted as V₀_OUT={0ₓ}.
(2) For a set representation of the node V₁:
2.1 For the input node set of the nodes V₁ containing a tensor variable: the various nodes of the computation graph are accessed in a node order. Starting from the node V₁, the input node set of the nodes V₁ is a union set of the output node sets of the precursor node V₀ and node V₈, which is denoted as V₁_IN=V₀_OUT∪V₈_OUT={0ₓ, 2_{y}, 4ₓ, 7ₓ, 8_{z}}.
2.2 For the output node set of the node V₁ containing a tensor variable: the output node set of the node V₁ is equal to the input node set of the nodes V₁, which is denoted as V₁_OUT={0ₓ, 2_{y}, 4ₓ, 7ₓ, 8_{z}}.

The set representation of the node V₂ is denoted as:

V₂_IN=V₁_OUT={0ₓ, 2_{y}, 4ₓ, 7ₓ, 8_{z}},

V₂_OUT=V₂_IN={0ₓ, 2_{y}, 4ₓ, 7ₓ, 8_{z}};

The set representation of the node V₃ is denoted as:

V₃_IN=V₂_OUT={0ₓ, 2_{y}, 4ₓ, 7ₓ, 8_{z}},

V₃_OUT=V₃_IN={0ₓ, 2_{y}, 4ₓ, 7ₓ, 8_{z}};

The set representation of the node V₄ is denoted as:

V₄_IN=V₃_OUT={0ₓ, 2_{y}, 4ₓ, 7ₓ, 8_{z}},

V₄_OUT=(V₃_IN\{0ₓ, 4ₓ, 7ₓ})∪{4ₓ}={2_{y}, 4ₓ, 8_{z}};

The set representation of the node V₅ is denoted as:

V₅_IN=V₃_OUT∪V₄_OUT={0ₓ, 2_{y}, 4ₓ, 7ₓ, 8_{z}},

V₅_OUT=(V₅_IN\{8_{z}})∪{5_{z}}={0ₓ, 2_{y}, 4ₓ, 7ₓ, 5_{z}};

The set representation of the node V₆ is denoted as:

V₆_IN=V₅_OUT={0ₓ, 2_{y}, 4ₓ, 7ₓ, 5_{z}},

V₆_OUT=V₆_IN={0ₓ, 2_{y}, 4ₓ, 7ₓ, 5_{z}};

The set representation of the node V₇ is denoted as:

V₇_IN=V₆_OUT={0ₓ, 2_{y}, 4ₓ, 7ₓ, 5_{z}},

V₇_OUT=(V₇_IN\{0ₓ, 4ₓ, 7ₓ})∪{7ₓ}={2_{y}, 5_{z}, 7ₓ};

The set representation of the node V₈ is denoted as:

V₈_IN=V₆_OUT∪V₇_OUT={0ₓ, 2_{y}, 4ₓ, 7ₓ, 5_{z}},

V₈_OUT=(V₈_IN\{5_{z}})∪{8_{z}}={0ₓ, 2_{y}, 4ₓ, 7ₓ, 8_{z}};

The set representation of the node V₉ is denoted as V₉_IN=V₁_OUT={0ₓ, 2_{y}, 4ₓ, 7ₓ, 8_{z}}.

Through the above two rounds of iterations, the node elements contained in the sets of the nodes containing the tensor variables of the intermediate representation no longer change, and achieve fixed nodes. The set of the fixed nodes is defined as intermediate representations based on the sets of the nodes containing the tensor variables.

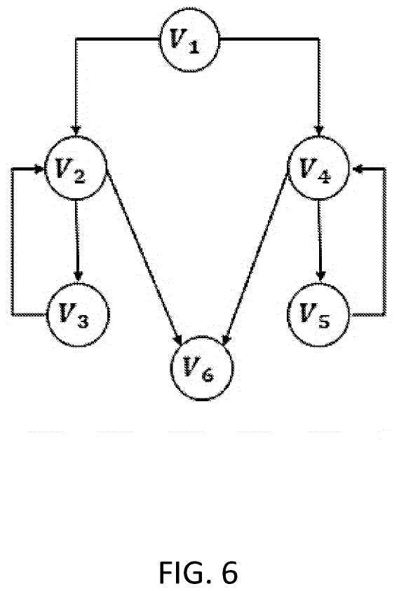

Referring to FIG. 6, a diagram of a dependency relationship among the input node sets of the various nodes of the computation graph is shown. A dependency relationship among nodes in the computation graph is analyzed:
a relationship between the input node sets of the various nodes of the computation graph is analyzed and deduced.

The output node sets of the various nodes can be represented by the input node sets, so that only the relationship between the input node sets of the various nodes needs to be deduced.

A process of deducing the relationship between the input node sets of the various nodes of the computation graph shown in FIG. 6 includes:

V₁_IN={ };

V₂_IN=V₁_IN∪(V₃_IN\{V₃, V₅, V₆})∪{V₃};

V₃_IN=V₂_IN;

V₄_IN=V₁_IN∪(V₅_IN\{V₃, V₅, V₆})∪{V₅};

V₅_IN=V₄_IN;

V₆_IN=V₂_IN∪V₄_IN.

A work stack of a node to be processed is constructed and saved:
the computation graph is traversed according to a topological order, and the nodes in the computation graph are pressed into the work stack in sequence.

The node elements contained in the work stack are initialized to be in a nonactivated state:
all the nodes of the computation graph that have not been executed are initialized to be in a nonactivated state.

A stack top node element is popped out from the work stack, an input node set of the stack top node element is deduced by using the dependency relationship, and the input node set of the stack top node element obtained in a current round of iteration is updated:
a stack top node element is popped out from the work stack, i.e. a stack top node element of the work stack is popped out from the stack; and
the input node set of the pop-out stack top node element is added into the work stack by using the dependency relationship, and the input node set of the stack top node element obtained in the current round of iteration is updated.

The stack top node elements that depend the last step are added to a stack top position in sequence, the current work stack is updated, and the last step is repeated until the work stack is empty:

The last four steps include the following processes of iteratively deducing the fixed node sets based on the nodes containing the tensor variables:

In a first step, a work stack of a node to be processed is constructed and saved. The saved work stack of the node to be processed is constructed as [V₁_IN, V₂_IN, V₃_IN, V₄_IN, V₅_IN, V₆IN].

In a second step, the node elements contained in the work stack are initialized to be in a nonactivated state. The elements in the work stack are initialized to be in the nonactivated state marked by [symbol] . Table 1 shows the states of the input node sets of the various nodes in the work stack.

TABLE 1

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |

In a third step, an element at a stack top of the work stack is processed. The processing of an element at a stack top of the work stack includes the following processes:

First, a stack top node element V₁_IN pops out of the work stack. The stack top node element pops out of the work stack, which refers to that the stack top node element V₁_IN of the work stack pops out of the stack. Since the input node set of a node V₁_IN is an empty set, the node V₁_IN is updated from the nonactivated state [symbol] to an empty set state { }.

Second, node sets that depend on the popped-out node V₁_IN are added to the work stack. The process of adding the node sets that depend on the popped-out node V₁_IN to the work stack is as follows: since the sets that depend on the node V₁_IN contain the node V₂_IN and the node V₄_IN, a dependent node set {V₂_IN, V₄_IN} is added to the stack top. After the above steps, the states of the input node sets of the various nodes in the work stack are updated as those shown in Table 2.

TABLE 2

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, V₃_IN, | | | | | | |
| V₄_IN, V₅_IN, | | | | | | |
| V₆_IN] | | | | | | |

Third, a stack top node element V₂_IN pops out of the work stack. The stack top node element pops out of the work stack, which refers to that stack top node element V₂_IN of the work stack pops out of the stack, and V₂_IN={V₃} is deduced according to V₂_IN=V₁_IN∪(V₃_IN\{V₃, V₅, V₆})∪{V₃} and V₁_IN={ }. Therefore, the node V₂_IN is updated from the nonactivated state [symbol] to the state {V₃}.

Fourth, node sets that depend on the popped-out node V₂_IN are added to the work stack. The process of adding the node sets that depend on the popped-out node V₂_IN to the work stack is as follows: since the sets that depend on the node V₂_IN contain the node V₃_IN and the node V₆_IN, a dependent node set {V₃_IN, V₆IN} is added to the stack top. After the above steps, the states of the input node sets of the various nodes in the work stack are updated as those shown in Table 3.

TABLE 3

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, | | | | | | |
| V₄_IN, V₅_IN, | | | | | | |
| V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, | | | | | | |
| V₂_IN, V₃_IN, | | | | | | |
| V₄_IN, V₅_IN, | | | | | | |
| V₆_IN] | | | | | | |

Fifth, a stack top node element V₃_IN pops out of the work stack. The stack top node element pops out of the work stack, which refers to that the stack top node element V₃_IN of the work stack pops out of the stack, and V₃_IN={V₃} is deduced according to V₃_IN=V₂_IN=V₁_IN∪(V₃_IN\{V₃, V₅, V₆})∪{V₃} and V₁_IN={ }. Therefore, the node V₃_IN is updated from the nonactivated state [symbol] to the state {V₃}.

Sixth, node sets that depend on the popped-out node V₃_IN are added to the work stack. The process of adding the node sets that depend on the popped-out node V₃_IN to the work stack is as follows: since the sets that depend on the node V₃_IN contain the node V₂_IN, the dependent node set {V₂_IN} is added to the stack top. After the above steps, the states of the input node sets of the various nodes in the work stack are updated as those shown in Table 4.

TABLE 4

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, V₃_IN, | | | | | | |
| V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, | | | | | | |
| V₂_IN, V₃_IN, | | | | | | |
| V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |

Seventh, a stack top node element V₂_IN pops out of the work stack. The stack top node element pops out of the work stack, which refers to that the stack top node element V₂_IN of the work stack pops out of the stack, and V₂_IN={V₃} is deduced according to V₂_IN=V₁_IN∪(V₃_IN\{V₃, V₅, V₆})∪{V₃} and V₁_IN={ }. Since the set elements of the node V₂_IN do not change, the node V₂_IN is kept in an activated state {V₃}.

Eighth, node sets that depend on the popped-out node V₂_IN are added to the work stack. Since the set elements of the node V₂_IN do not change, no node sets that depend on the node V₂_IN are added to the work stack. After the above steps, the states of the input node sets of the various nodes in the work stack are updated as those shown in Table 5.

TABLE 5

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |

Ninth, a stack top node element V₆_IN pops out of the work stack. The stack top node element pops out of the work stack, which refers to that the stack top node element V₆_IN of the work stack pops out of the stack, and V₆_IN={V₃} is deduced according to V₆_IN=V₂_IN∪V₄_IN and V₂_IN={V₃}. Therefore, the node V₆_IN is updated from the nonactivated state [symbol] to the state {V₃}.

Tenth, node sets that depend on the popped-out node V₆_IN are added to the work stack. Since there are no other nodes that depend on the node V₆_IN, no node sets that depend on the node V₆_IN are added to the work stack. After the above steps, the states of the input node sets of the various nodes in the work stack are updated as those shown in Table 6.

TABLE 6

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | { } | [symbol] | [symbol] | [symbol] | [symbol] | [symbol] |
| V₂_IN, V₃_IN, | | | | | | |
| V₄_IN, V₅_IN, | | | | | | |
| V₆_IN] | | | | | | |
| [V₃_IN, V₆_IN, | { } | {V₃} | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | { } | { } | {V₃} | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | { } | { } | { } | [symbol] | [symbol] | [symbol] |
| V₂_IN, V₃_IN, | | | | | | |
| V₄_IN, V₅_IN, | | | | | | |
| V₆_IN] | | | | | | |

Eleventh, a stack top node element V₄_IN pops out of the work stack. The stack top node element pops out of the work stack, which refers to that the stack top node element V₄_IN of the work stack pops out of the stack, and V₄_IN={V₅} is deduced according to V₄_IN=V₁_IN∪(V₅_IN\{V₃, V₅, V₆})∪{V₅} and V₁_IN={ }. Therefore, the node V₄_IN is updated from the nonactivated state [symbol] to the state {V₅}.

Twelfth, node sets that depend on the popped-out node V₄_IN are added to the work stack. Since the set that depends on the node V₄_IN contains the node V₅_IN and the node V₆_IN, a node set {V₅_IN, V₆_IN} is added to the stack top. After the above steps, the states of the input node sets of the various nodes in the work stack are updated as those shown in Table 7.

TABLE 7

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |

Thirteenth, a stack top node element V₅_IN pops out of the work stack. The stack top node element pops out of the work stack, which refers to that the stack top node element V₅_IN of the work stack pops out of the stack, and V₅_IN={V₅} is deduced according to V₅_IN=V₄_IN={V₅}. Therefore, the node V₅_IN is updated from the nonactivated state [symbol] to the state {V₅}.

Fourteenth, node sets that depend on the popped-out node V₅_IN are added to the work stack. Since the set that depends on the node V₅_IN contains the node V₄_IN, a node set {V₄_IN} is added to the stack top. After the above steps, the states of the input node sets of the various nodes in the work stack are updated as those shown in Table 8.

TABLE 8

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, V₃_IN, | | | | | | |
| V₄_IN, V₅_IN, | | | | | | |
| V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |

Fifteenth, a stack top node element V₄_IN pops out of the work stack. The stack top node element pops out of the work stack, which refers to that the stack top node element V₄_IN of the work stack pops out of the stack, and V₄_IN={V₅} is deduced according to V₄_IN=V₁_IN∪(V₅_IN\{V₃, V₅, V₆})∪{V₅} and V₁_IN={ }. Therefore, the node V₄_IN is kept in an activated state {V₅}.

Sixteenth, node sets that depend on the popped-out node V₄_IN are added to the work stack. Since the set elements of the node V₄_IN do not change, no node sets that depend on the node V₄_IN are added to the work stack. After the above steps, the states of the input node sets of the various nodes in the work stack are updated as those shown in Table 9.

TABLE 9

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |

Seventeenth, a stack top node element V₆_IN pops out of the work stack. The stack top node element pops out of the work stack, which refers to that the stack top node element V₆_IN of the work stack pops out of the stack, and V₆_IN={V₃, V₅} is deduced according to V₆_IN=V₂_IN∪V₄_IN. Therefore, the node V₆_IN is updated from the activated state to the state {V₃, V₅}.

Eighteenth, node sets that depend on the popped-out node V₆_IN are added to the work stack. Since there are no other nodes that depend on the node V₆_IN, no node sets that depend on the node V₆_IN are added to the work stack. After the above steps, the states of the input node sets of the various nodes in the work stack are updated as those shown in Table 10.

TABLE 10

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |

Nineteenth, a stack top node element V₄_IN pops out of the work stack. The stack top node element pops out of the work stack, which refers to that the stack top node element V₄_IN of the work stack pops out of the stack, and V₄_IN={V₅} is deduced according to V₄_IN=V₁_IN∪(V₅_IN\{V₃, V₅, V₆})∪{V₅} and V₁_IN={ }. Therefore, the node V₄_IN is kept in an activated state {V₅}.

Twentieth, node sets that depend on the popped-out node V₄_IN are added to the work stack. Since the set elements of the node V₄_IN do not change, no node sets that depend on the node V₄_IN are added to the work stack. After the above steps, the states of the input node sets of the various nodes in the work stack are updated as those shown in Table 11.

TABLE 11

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |

Twenty-first, a stack top node element V₂_IN pops out of the work stack. The stack top node element pops out of the work stack, which refers to that the stack top node element V₂_IN of the work stack pops out of the stack, and V₂_IN={V₃} is deduced according to V₂_IN=V₁_IN∪(V₃_IN\{V₃, V₅, V₆})∪{V₃} and V₁_IN={ }. Since the set elements of the node V₂_IN do not change, the node V₂_IN is kept in an activated state {V₃}.

Twenty-second, node sets that depend on the popped-out node V₂_IN are added to the work stack. Since the set elements of the node V₂_IN do not change, no node sets that depend on node V₂_IN are added to the work stack. After the above steps, the states of the input node sets of the various nodes in the work stack are updated as those shown in Table 12.

TABLE 12

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |
| [V₃_IN, V₄_IN, | [ ] | [V₃] | [V₃] | [V₃] | [V₃] | [V₃, V₃] |
| V₅_IN, V₆_IN] | | | | | | |

Twenty-third, a stack top node element V₃_IN pops out of the work stack. The stack top node element pops out of the work stack, which refers to that the stack top node element V₃_IN of the work stack pops out of the stack, and V₃_IN is deduced according to V₃_IN=V₂_IN=V₁_IN∪(V₃_IN\{V₃, V₅, V₆})∪{V₃} and V₁_IN={ }. Therefore, the activated state of the node V₃_IN is kept in the state {V₃}.

Twenty-fourth, node sets that depend on the popped-out node V₃_IN are added to the work stack. The process of adding the node sets that depend on the popped-out node V₃_IN to the work stack is as follows: since the set elements of the node V₃_IN do not change, no node sets that depend on node V₃_IN are added to the work stack. After the above steps, the states of the input node sets of the various nodes in the work stack are updated as those shown in Table 13.

TABLE 13

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |
| [V₃_IN, V₄_IN, | [ ] | [V₃] | [V₃] | [V₃] | [V₃] | [V₃, V₃] |
| V₅_IN, V₆_IN] | | | | | | |

Twenty-fifth, a stack top node element V₄_IN pops out of the work stack. The stack top node element pops out of the work stack, which refers to that the stack top node element V₄_IN of the work stack pops out of the stack, and, V₄_IN={V₅} is deduced according to V₄_IN=V₁_IN∪(V₅_IN\{V₃, V₅, V₆})∪{V₅} and V₁_IN={ }. Therefore, the node V₄_IN is kept in an activated state {V₅}.

Twenty-sixth, node sets that depend on the popped-out node V₄_IN are added to the work stack. Since the set elements of the node V₄_IN do not change, no node sets that depend on the node V₄_IN are added to the work stack. After the above steps, the states of the input node sets of the various nodes in the work stack are updated as those shown in Table 14.

TABLE 14

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |
| [V₃_IN, V₄_IN, | [ ] | [V₃] | [V₃] | [V₃] | [V₃] | [V₃, V₃] |
| V₅_IN, V₆_IN] | | | | | | |
| [V₄_IN, V₅_IN, | [ ] | [V₃] | [V₃] | [V₃] | [V₃] | [V₃, V₃] |
| V₆_IN] | | | | | | |
| [V₅_IN, V₆_IN] | [ ] | [V₃] | [V₃] | [V₃] | [V₃] | [V₃, V₃] |

Twenty-seventh, a stack top node element V₅_IN pops out of the work stack. The stack top node element pops out of the work stack, which refers to that the stack top node element V₅_IN of the work stack pops out of the stack, and V₅_{_{IN}}={V₅} is deduced according to V₅_IN=V₄_IN={V₅}. Therefore, the activated state of the node V₅_IN is kept in the state {V₅}.

Twenty-eighth, node sets that depend on the popped-out node V₅_IN are added to the work stack. Since the set elements of the node V₅_IN do not change, no node sets that depend on the node V₅_IN are added to the work stack. After the above steps, the states of the input node sets of the various nodes in the work stack are updated as those shown in Table 15.

TABLE 15

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, | | | | | | |
| V₂_IN, V₃_IN, | | | | | | |
| V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |
| [V₃_IN, V₄_IN, | [ ] | [V₃] | [V₃] | [V₃] | [V₃] | [V₃, V₃] |
| V₅_IN, V₆_IN] | | | | | | |
| [V₄_IN, V₅_IN, | [ ] | [V₃] | [V₃] | [V₃] | [V₃] | [V₃, V₃] |
| V₆_IN] | | | | | | |
| [V₅_IN, V₆_IN] | [ ] | [V₃] | [V₃] | [V₃] | [V₃] | [V₃, V₃] |
| [V₆_IN] | [ ] | [V₃] | [V₃] | [V₃] | [V₃] | [V₃, V₃] |

Twenty-ninth, a stack top node element V₆_IN pops out of the work stack. The stack top node element pops out of the work stack, which refers to that the stack top node element V₆_IN of the work stack pops out of the stack, and V₆_IN={V₃, V₅} is deduced according to V₆_IN=V₂_IN∪V₄_IN and V₂_IN={V₃}, as well as V₄_IN={V₅}. Therefore, the activated state of the node V₆_IN is kept in the state {V₃, V₅}.

Thirtieth, node sets that depend on the popped-out node V₆_IN are added to the work stack. Since there are no other nodes that depend on the node V₆_IN, no node sets that depend on the node V₆_IN are added to the work stack. After the above steps, the states of the input node sets of the various nodes in the work stack are updated as those shown in Table 16.

TABLE 16

| Work stack | V₁_IN | V₂_IN | V₃_IN | V₄_IN | V₅_IN | V₆_IN |
|---|---|---|---|---|---|---|
| [V₁_IN, V₂_IN, | [symbol] | [symbol] | [symbol] | [symbol] | [symbol] | [symbol] |
| V₃_IN, V₄_IN, | | | | | | |
| V₅_IN, V₆_IN] | | | | | | |
| [V₂_IN, V₄_IN, | [ ] | [symbol] | [symbol] | [symbol] | [symbol] | [symbol] |
| V₂_IN, | | | | | | |
| V₃_IN, V₄_IN, | | | | | | |
| V₅_IN, V₆_IN] | | | | | | |
| [V₃_IN, V₆_IN, | [ ] | [V₃] | [symbol] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₂_IN, V₆_IN, | [ ] | [V₃] | [V₃] | [symbol] | [symbol] | [symbol] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [symbol] | [symbol] | [symbol] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [symbol] | [symbol] | [V₃] |
| V₃_IN, V₄_IN, | | | | | | |
| V₅_IN, V₆_IN] | | | | | | |
| [V₅_IN, V₆_IN, | [ ] | [V₃] | [V₃] | [V₃] | [symbol] | [V₃] |
| V₄_IN, V₂_IN, | | | | | | |
| V₃_IN, V₄_IN, | | | | | | |
| V₅_IN, V₆_IN] | | | | | | |
| [V₄_IN, V₆_IN, | [ ] | [V₃] | [V₃] | [V₃] | [V₃] | [V₃] |
| V₄_IN, V₂_IN, | | | | | | |
| V₃_IN, V₄_IN, | | | | | | |
| V₅_IN, V₆_IN] | | | | | | |
| [V₆_IN, V₄_IN, | [ ] | [V₃] | [V₃] | [V₃] | [V₃] | [V₃] |
| V₂_IN, | | | | | | |
| V₃_IN, V₄_IN, | | | | | | |
| V₅_IN, V₆_IN] | | | | | | |
| [V₄_IN, V₂_IN, | [ ] | [V₃] | [V₃] | [V₃] | [V₃] | [V₃, V₃] |
| V₃_IN, V₄_IN, | | | | | | |
| V₅_IN, V₆_IN] | | | | | | |
| [V₂_IN, V₃_IN, | [ ] | [V₃] | [V₃] | [V₃] | [V₃] | [V₃, V₃] |
| V₄_IN, | | | | | | |
| V₅_IN, V₆_IN] | | | | | | |
| [V₃_IN, V₄_IN, | [ ] | [V₃] | [V₃] | [V₃] | [V₃] | [V₃, V₃] |
| V₅_IN, V₆_IN] | | | | | | |
| [V₄_IN, V₅_IN, | [ ] | [V₃] | [V₃] | [V₃] | [V₃] | [V₃, V₃] |
| V₆_IN] | | | | | | |
| [V₅_IN, V₆_IN] | [ ] | [V₃] | [V₃] | [V₃] | [V₃] | [V₃, V₃] |
| [V₆_IN] | [ ] | [V₃] | [V₃] | [V₃] | [V₃] | [V₃, V₃] |
| [ ] | [ ] | [V₃] | [V₃] | [V₃] | [V₃] | [V₃, V₃] |

An intermediate representation in a fixed node state is implemented by using a bit vector:
when the input node sets of the various nodes in the intermediate representation of the computation graph reach the fixed node state, node elements contained are mapped to 1, and other node elements are mapped to 0.

Referring to Table 17, a bit vector representation of the intermediate representation in the fixed node state is shown.

TABLE 17

| Input set | V₁ | V₂ | V₃ | V₄ | V₅ | V₆ |
|---|---|---|---|---|---|---|
| V₁_IN | 0 | 0 | 0 | 0 | 0 | 0 |
| V₂_IN | 0 | 0 | 1 | 0 | 0 | 0 |
| V₃_IN | 0 | 0 | 1 | 0 | 0 | 0 |
| V₄_IN | 0 | 0 | 0 | 0 | 1 | 0 |
| V₅_IN | 0 | 0 | 0 | 0 | 1 | 0 |
| V₆_IN | 0 | 0 | 1 | 0 | 1 | 0 |

Registers are allocated for tensor variables contained in nodes of the intermediate representation that achieves the fixed node state.
idle registers are allocated for tensor variables contained in nodes whose node elements contained are mapped to 1 when the input node sets the last step reach the fixed node state.

Corresponding to the foregoing embodiment of the optimization method for compiling a computation graph, the disclosure further provides an embodiment of an optimization apparatus for compiling a computation graph. Through the above optimization method for compiling a computation graph, a work stack for the intermediate representation is used to improve the utilization efficiency of compiling memory, reduce the required amount computer memory resources for running a neural network model, save the register resources of CPU cores which need to be allocated when the neural network model is running on the computer, and finally improve data training efficiency and data input and output efficiency of the neural network model.

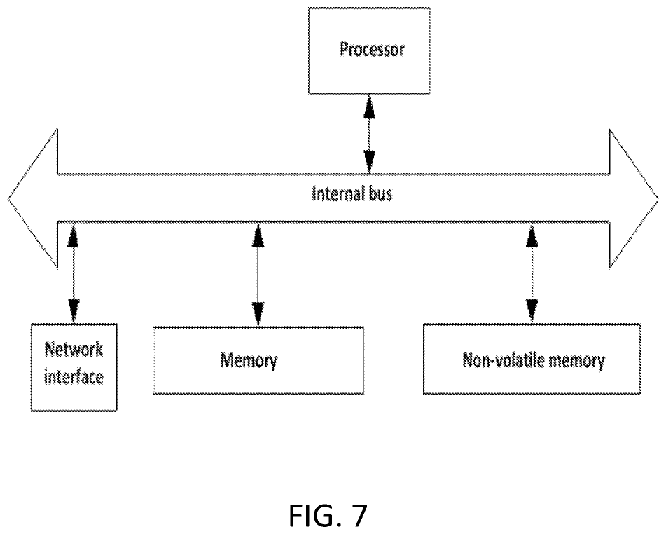

Referring to FIG. 7, the optimization apparatus for compiling a computation graph includes a memory and one or more processors, the memory stores executable instructions; and the one or more processors execute the executable instructions to implement the optimization method for compiling a computation graph in the above embodiment.

The embodiment of the optimization apparatus for compiling a computation graph of the disclosure can be applied to any device with data processing capability. Any device with data processing capability can be a device or apparatus such as a computer. The apparatus embodiment may be implemented by software, or may be implemented by hardware or a combination of software and hardware. Software implementation is taken as an example, an apparatus in a logical sense is formed by reading corresponding computer program instructions in a nonvolatile memory into an internal memory through a processor of any device with the data processing capability where it is located. In terms of hardware, as shown in FIG. 7, a hardware structure diagram of any device with the data processing capability where the optimization apparatus for compiling a computation graph of the disclosure is located is illustrated. In addition to the processor, internal memory, network interface, and non-volatile memory shown in FIG. 7, any device with the data processing capability where the apparatus in the embodiment is located may also include other hardware usually according to the actual functions of any device with the data processing capability, and repeated descriptions are omitted here. Through the above optimization method for compiling a computation graph, a work stack for the intermediate representation is used to improve the utilization efficiency of compiling memory, reduce the required amount computer memory resources for running a neural network model, save the register resources of CPU cores which need to be allocated when the neural network model is running on the computer, and finally improve data training efficiency and data input and output efficiency of the neural network model.

For details of the implementation process of the functions and effects of all units in the above apparatus, the implementation processes of the corresponding steps in the above method are referred to, and repeated descriptions are omitted here.

For the apparatus embodiment, since it basically corresponds to the method embodiment, reference may be made to the partial description of the method embodiment for related parts. The device embodiments described above are only illustrative, and the units described as separate components may or may not be physically separated, and the components displayed as units may or may not be physical units, that is, they may be located in one place, or may be distributed to multiple network units. Some or all of the modules may be selected according to actual needs to achieve the objectives of the solutions of the disclosure. Those of ordinary skill in the art can understand and implement it without creative effort.

An embodiment of the disclosure further provides a computer-readable storage medium, which stores a program, wherein the program, when executed by a processor, implements the optimization method for compiling a computation graph in the above embodiment. By the program on the computer-readable storage medium, when executed by a processor, through the above optimization method for compiling a computation graph, a work stack for the intermediate representation is used to improve the utilization efficiency of compiling memory, reduce the required amount computer memory resources for running a neural network model, save the register resources of CPU cores which need to be allocated when the neural network model is running on the computer, and finally improve data training efficiency and data input and output efficiency of the neural network model.

The computer-readable storage medium may be an internal storage unit of any device with the data processing capability described in any of the foregoing embodiments, such as a hard disk or a memory. The computer-readable storage medium can also be an external storage device of any device with the data processing capability, such as a plug-in hard disk, a smart media card (SMC), an SD card, and a flash card. Further, the computer-readable storage medium may also include both an internal storage unit of any device with the data processing capability and an external storage device. The computer-readable storage medium is used for storing the computer program and other programs and data required by any device with the data processing capability, and can also be used for temporarily storing data that has been output or will be output.

The above descriptions are only preferred embodiments of the disclosure, and are not intended to limit the disclosure. For those skilled in the art, the disclosure can have various changes and variations. Any modification, equivalent replacement, improvement, etc. made within the spirit and principle of the disclosure shall all fall within the protection scope of the disclosure.

1. An optimization method for compiling a computation graph representing a neural network, comprising:
converting the computation graph into an intermediate representation by iteratively deducing any input node set and an output node set of a node of the computation graph, until the input node set and the output node set no longer change, wherein the input node set is a union set of output node sets of all precursor nodes of the node, and the output node set contains any tensor variables in the input node set that are not redefined in the node and any tensor variable defined in the node;
allocating idle registers of a processor of a computer system for tensor variables in the node; and
configuring the computer system according to the intermediate representation such that the computer system implements the neural network, thereby reducing a requirement for memory of the computer system.

2. (canceled)

3. The optimization method according to claim 1, wherein iteratively deducing any input node set and the output node set of the node of the computation graph comprises:
obtaining a dependency relationship among nodes of the computation graph;
constructing a work stack of the nodes of the computation graph according to the dependency relationship; and
iteratively popping a stack top node from the work stack, deducing any input node set of the stack top node using the dependency relationship and pushing nodes that depend on the stack top node into the work stack, until the work stack is empty.

4. The optimization method according to claim 3, wherein constructing the work stack comprising pushing the nodes of the computation graph into the work stack according to a topological order in the dependency relationship.

5. The optimization method according to claim 3, further comprising implementing the intermediate representation using a bit vector.

6. (canceled)

7. (canceled)

8. (canceled)

9. An optimization apparatus, comprising a non-transitory memory and one or more processors, wherein the memory stores executable instructions; the one or more processors execute the executable instructions to implement the optimization method according to claim 1.

10. A non-transitory computer-readable storage medium, which stores a program, wherein the program, when executed by a processor, implements the optimization method according to claim 1.
